(19) United States
(12) Patent Application Publication
(10) Pub. No.: US 2016/0292237 A1
(43) Pub. Date: Oct. 6, 2016

(54) NUMERICAL CONTROLLER WITH AMBIGUOUS SEARCH FUNCTION IN PROGRAM

(71) Applicant: FANUC Corporation, Minamitsuru-gun (JP)

(72) Inventor: Koji SATO, Minamitsuru-gun (JP)

(21) Appl. No.: 15/067,218

(22) Filed: Mar. 11, 2016

(30) Foreign Application Priority Data
Mar. 30, 2015 (JP) 2015-068984

(51) Int. Cl. G06F 17/30

(52) U.S. Cl. CPC G06F 17/30554; G06F 17/30424

(57) ABSTRACT

A numerical controller stores ambiguous search information including a keyword (ambiguous keyword) that does not directly writes a word used in the machining program and a search phrase associated with the ambiguous keyword. When an ambiguous search command including the ambiguous keyword is accepted, a search expression is created based on the ambiguous search command and the stored ambiguous search information, the machining program is searched according to the search expression, and the result of the search is displayed on a screen.

### BACKGROUND OF THE INVENTION

1. Field of the Invention

The present invention relates to a numerical controller, and more particularly, to a numerical controller capable of enabling even a beginner to easily search an object code.

2. Description of the Related Art

In confirming or editing the command contents of a machining program in a numerical controller, an operator searches the machining program using character strings of a target command by means of a standard search function of the numerical controller.

According to a common search function, a line that perfectly agrees with a string specified as a search object from the machining program is displayed as a search result. There is generally known a higher-quality search function or the like based on regular expressions such that a group of strings is used as a search object by specifying a part of each string as a pattern. An example of a conventional technique in which such regular expressions are applied to a numerical controller is disclosed in Japanese Patent Application Laid-Open No. 2007-286960. In this numerical controller, the regular expressions are used to search information on machining.

An operator can properly extract an object block in a machining program by applying a search function based on these regular expressions to the search of the machining program. In order to perform a proper search using this function, however, the operator should be familiar with command systems, such as G-codes, used in the machining program and a method for specifying a regular expression pattern. Thus, there is a problem that beginners who are not familiar with these measures cannot specify a proper search string.

Further, the G-codes and other command systems used in the machining program are each composed of a number of words (address plus numerical value) and cannot be easily discriminated at a glance even if they are commands with different meanings in machining control. Thus, there is a problem that even moderately experienced operators cannot easily specify a proper search string based on a regular expression.

### SUMMARY OF THE INVENTION

Accordingly, the object of the present invention is to provide a numerical controller capable of enabling even a beginner to easily search an object code.

A numerical controller according to the present invention searches a machining program based on a specified search condition and displays the result of the search. The numerical controller comprises: an ambiguous keyword storage area stored with ambiguous search information including a keyword that does not directly writes a word used in the machining program, being an ambiguous keyword, and a search phrase associated with the ambiguous keyword; an ambiguous search condition input unit configured to accept an ambiguous search condition including the ambiguous keyword; an ambiguous search execution unit configured to create a search expression, based on the ambiguous search condition accepted by the ambiguous search condition input unit and the ambiguous search information stored in the ambiguous keyword storage area, and search the machining program according to the search expression; and a search result display unit configured to display the result of the search by the ambiguous search execution unit.

The search phrase may comprise a character string, a plurality of character strings, a regular expression pattern, or a search logical expression combining the same.

The search result display unit may be configured to list-display lines matched to the search expression included in the machining program searched by the ambiguous search execution unit and also display the machining program. Further, the search result display unit may be configured to perform display control such that a line of the machining program corresponding to a selected one of the lines matched to the list-displayed search expression is displayed on a screen.

According to the present invention, even a beginner is enabled to easily search a machining program, so that an improvement in working efficiency can be expected. Since a proper search string for the search of an object block need not be specified, moreover, search errors due to wrong search strings can be prevented.

### BRIEF DESCRIPTION OF THE DRAWINGS

The above and other objects and features of the present invention will be obvious from the ensuing description of embodiments with reference to the accompanying drawings, in which:

FIG. 1 is a diagram showing an example of a dialog box for the input of search conditions using ambiguous keywords based on an ambiguous keyword search function of a numerical controller according to the present invention;

FIG. 2 is a diagram showing an example of the result of a search using the ambiguous keywords based on the ambiguous keyword search function of the numerical controller according to the present invention;

FIG. 3 is a functional block diagram of one embodiment of the numerical controller according to the present invention; and

FIG. 4 is a diagram showing an ambiguous keyword table of the numerical controller of FIG. 3 in which a plurality of ambiguous keywords are registered.

### DETAILED DESCRIPTION OF THE PREFERRED EMBODIMENTS

According to the present invention, there is provided a numerical controller with a search function capable of searching a machining program by only previously providing and checking an object item.

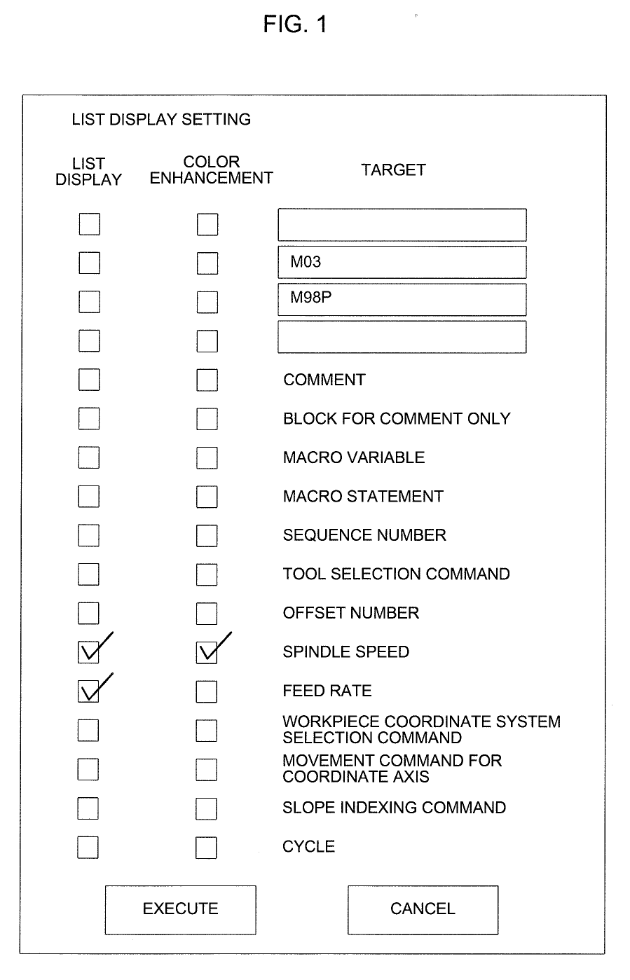

When an operator operates the numerical controller to execute an ambiguous keyword search function for the machining program, according to the present invention, a dialog box is displayed on the display of the numerical controller, as shown in FIG. 1.

Text boxes and ambiguous keywords are displayed in rows in a target column displayed on the dialog box shown in FIG. 1. Strings to be searched are input in the text boxes, and the ambiguous keywords are prepared by the ambiguous keyword search function of the numerical controller. Check boxes for instructing list display and check boxes for instructing color enhancement are provided on the left of the text boxes and the ambiguous keywords.

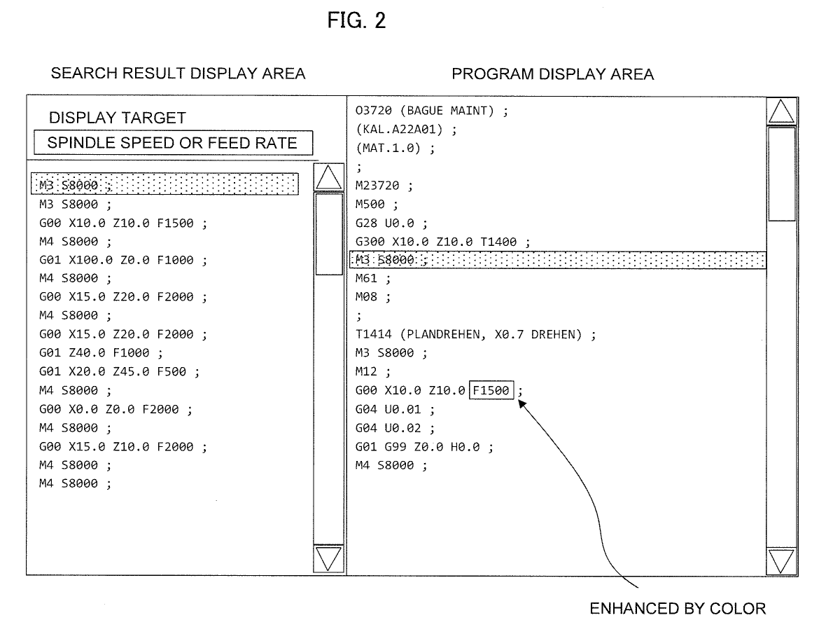

In performing normal search processing using the dialog box shown in FIG. 1, a search string to be searched and a regular expression pattern are input in any of the text boxes in the “target” column, and an “execute” button is selected with “list display” and/or “color enhancement” check boxes checked. Thereupon, the specified search string and the regular expression pattern are retrieved from the machining program and displayed on a search result screen (FIG. 2), which will be described later.

In the dialog box shown in FIG. 1, if the “execute” button is selected with the “list display” and/or “color enhancement” check boxes beside the ambiguous keywords checked, on the other hand, an ambiguous search using the ambiguous keywords corresponding to the check boxes is performed for the machining program and displayed on the search result screen (FIG. 2), which will be described later.

The “ambiguous keyword” is such a term as the spindle speed, feed rate, or tool selection command that is commonly used by operators who operate machine tools and numerical controllers and creators of machining programs. Although it is not a direct notation of a word (e.g., G00) used in the machining program, it is a term that indirectly leads to a word used in the machining program. The ambiguous keywords are managed in association with strings, sets of strings, or regular expression patterns used in the machining program in the numerical controller. When an operator selects and searches an ambiguous keyword, the ambiguous keyword is expanded into a search expression, based on the string, set of strings, or regular expression pattern associated with it in the numerical controller, and search processing is performed using the expanded search expression.

FIG. 2 is a diagram showing an example of the display screen on which the result of the search for the machining program is displayed.

In FIG. 2, a search string to be searched, regular expression pattern, or ambiguous keyword is displayed in the upper part of a “search result display area” on the left-hand side, and lines corresponding to the search strings, regular expression patterns, or ambiguous keywords checked in the “list display” check boxes, among other lines of the machining program matched to the search strings to be searched, regular expression patterns, or ambiguous keywords, are listed and displayed in the lower part.

The machining program to be searched is displayed in a “program display area” on the right-hand side of FIG. 2, and a search string as a search object, regular expression pattern, or ambiguous keyword that is checked in a “color enhancement” check box, among other strings matched to the search strings to be searched, regular expression patterns, or ambiguous keywords, is displayed in an enhanced color. Further, the “program display area” is associated with the display of the search result selected in the “search result display area”. When a line is selected in the “search result display area”, the display range in the “program display area” can be adjusted so that the selected line is displayed on the screen.

In the example shown in FIGS. 1 and 2, an ambiguous keyword search is performed in a situation where both the “list display” and “color enhancement” check boxes for the ambiguous keyword “spindle speed” are checked and the “list display” check box for the ambiguous keyword “feed rate” is also checked in the dialog box.

Consequently, as shown in FIG. 2, in the upper part of the “search result display area”, a message to the effect that the keyword search is an ambiguous keyword search based on the ambiguous keyword “spindle speed” and the ambiguous keyword “feed rate” is displayed, whereas in the lower part of the “search result display area”, a word “S0000” (0000 is any number) that command the spindle speed and a word “Fxxxx” (xxxx is a number with any number of digits) that command the feed rate, in the machining program, are retrieved and displayed.

Further, in a “program display area”, a word “Fxxxx” (xxxx is a number with any number of digits) that commands the feed rate in the machining program is displayed in an enhanced color.

Thus, in the numerical controller according to the present invention, when the execution of the ambiguous keyword search is commanded by selecting the ambiguous keyword (or checking the “list display” and “color enhancement” check boxes), the machining program to be searched is displayed in the “program display area”, and the search string as a search object, regular expression pattern, or ambiguous keyword that is checked in the “color enhancement” check box, among the other strings matched to the search strings to be searched, regular expression patterns, or ambiguous keywords, is displayed in an enhanced color. Further, the “program display area” is associated with the display of the search result selected in the “search result display area”. When a line is selected in the “search result display area”, the display range in the “program display area” can be adjusted so that the selected line is displayed on the screen.

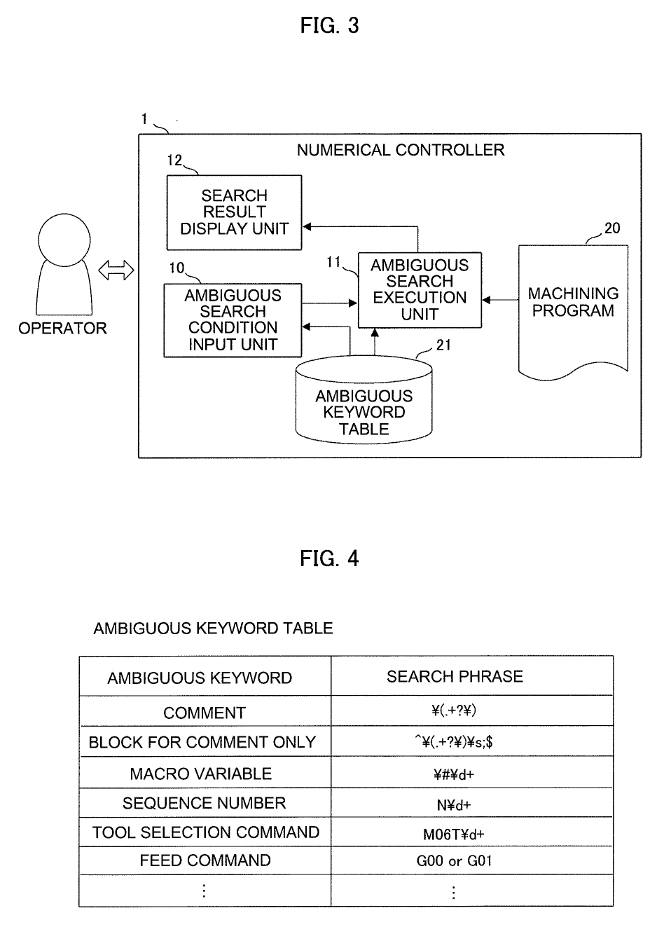

FIG. 3 is a functional block diagram of a numerical controller according to one embodiment of the present invention.

A numerical controller 1 comprises an ambiguous search condition input unit 10, ambiguous search execution unit 11, search result display unit 12, and ambiguous keyword table 21.

The ambiguous search condition input unit 10 presents to the operator a screen to which ambiguous search conditions, such as those shown in FIG. 1, are input, with reference to the ambiguous keywords registered in the ambiguous keyword table 21, and accepts the search conditions input by the operator through the screen.

As shown in FIG. 4, a plurality of ambiguous keywords that can be used in the numerical controller of the present embodiment is registered in the ambiguous keyword table 21 in a state where search phrases used for the search by the ambiguous keywords are associated with the individual registered ambiguous keywords. The search phrases associated with the ambiguous keywords each comprise a string, set of strings, regular expression pattern, or search logical expression combining the same which enables the search of a word string used in a machining program indirectly represented by the associated ambiguous keyword.

The ambiguous search execution unit 11 creates a search expression based on the search conditions accepted by the ambiguous search condition input unit 10 and performs an ambiguous search for a machining program 20 using the search expression. On detecting that the search conditions include an ambiguous keyword, the ambiguous search execution unit 11 acquires a search phrase associated with the ambiguous keyword with reference to the ambiguous keyword table 21, and creates the search expression for the ambiguous search for the machining program 20 using the acquired search phrase.

In the example shown in FIG. 1, for example, the ambiguous keywords “spindle speed” and “feed rate” are specified as the search conditions, so that a search phrase (e.g., regular expression pattern “SYd+1”) associated with the ambiguous keyword “spindle speed” and a search phrase (e.g., regular expression pattern “FYd+1”) associated with the ambiguous keyword “feed rate” are acquired from the ambiguous keyword table 21, and a search expression is created by combining these patterns by a logical condition OR.

The machining program 20 is searched using the created search expression and the result of the search is output to the search result display unit 12.

Based on the search result received from the ambiguous search execution unit 11, the search result display unit 12 outputs a search result display screen for the operator. In the numerical controller 1 of the present embodiment, a line of the machining program 20 matched to the search string, regular expression pattern, or ambiguous keyword that is checked in the “list display” check box, among other lines matched to the search expression created by the ambiguous search execution unit 11, is displayed in the “search result display area”. Further, a machining program is displayed in the “program display area” such that the string matched to the search string, regular expression pattern, or ambiguous keyword that is checked in the “list display” check box is displayed in an enhanced color.

The “program display area” is associated with the display of the search result selected in the “search result display area”. When a line is selected in the “search result display area”, the search result display unit 12 adjusts a display start line in the machining program (a range of the machining program displayed on the screen) for the “program display area” so that the line of the machining program corresponding to the selected line is displayed in the “program display area”.

Thus, the numerical controller 1 accepts the search conditions including the ambiguous keyword from the operator, performs the ambiguous search of the machining program, and displays a searched part for better understanding by the operator. Even in case the operator is not familiar with G-codes or regular expressions, therefore, he/she can search a target word in the machining program. Since the operator can search the word by only selecting a familiar term, moreover, search errors can be reduced without requiring a trial-and-error approach to create the search expression, so that an improvement in working efficiency can be expected. The latter effect is particularly suitable for the search of a program, such as the machining program, in which many of expressions in the program comprise words each composed of “address plus number” such that the creation of regular expression patterns for the search is difficult.

While an embodiment of the present invention has been described herein, the invention is not limited to the above-described embodiment and may be suitably modified and embodied in various forms.

For example, the numerical controller 1 may be provided with setting means by which the operator can set the ambiguous keyword table 21. If this is done, the operator can register a new ambiguous keyword in accordance with the use environment or edit the search phrase to customize a word to be searched with the ambiguous keyword.

Although the color enhancement is used in the machining program display area in the example described above, moreover, the searched string may be suitably emphasized by various display attributes, such as blinking, highlighting, enhancement, and the like.

1. A numerical controller which searches a machining program based on a specified search condition and displays the result of the search, the numerical controller comprising:
an ambiguous keyword storage area stored with ambiguous search information including a keyword that does not directly writes a word used in the machining program, being an ambiguous keyword, and a search phrase associated with the ambiguous keyword;
an ambiguous search condition input unit configured to accept an ambiguous search condition including the ambiguous keyword;
an ambiguous search execution unit configured to create a search expression, based on the ambiguous search condition accepted by the ambiguous search condition input unit and the ambiguous search information stored in the ambiguous keyword storage area, and search the machining program according to the search expression; and
a search result display unit configured to display the result of the search by the ambiguous search execution unit.

2. The numerical controller according to claim 1, wherein the search phrase comprises a character string, a plurality of character strings, a regular expression pattern, or a search logical expression combining the same.

3. The numerical controller according to claim 1, wherein the search result display unit list-displays lines matched to the search expression included in the machining program searched by the ambiguous search execution unit and also displays the machining program.

4. The numerical controller according to claim 3, wherein the search result display unit performs display control such that a line of the machining program corresponding to a selected one of the lines matched to the list-displayed search expression is displayed on a screen.

5. The numerical controller according to claim 2, wherein the search result display unit list-displays lines matched to the search expression included in the machining program searched by the ambiguous search execution unit and also displays the machining program.
